(19) United States
(12) Patent Application Publication
(10) Pub. No.: US 2007/0114182 A1
(43) Pub. Date: May 24, 2007

(54) Wastewater treatment system for a marine vessel

(75) Inventors: Steven Christopher DePoli, Victoria (CA); Antony Foster Hilliard, Saltspring Island (CA)

Correspondence Address: ANISSIMOFF & ASSOCIATES;RICHMOND NORTH OFFICE CENTRE, SUITE 201, 235 NORTH CENTRE RD., LONDON, ON, N5X 4E7, CA

(73) Assignee: Hydroxyl Systems Inc.

(21) Appl. No.: 11/281,428

(22) Filed: Nov. 18, 2005

(51) Int. Cl. C02F 1/24; C02F 3/04

(52) U.S. Cl. 210/703; 210/221.2; 210/617; 210/202; 210/205; 210/206

(57) ABSTRACT

A wastewater treatment system for use on a marine vessel comprising an aerobic fixed film biological reactor, a tubular flocculator and a dissolved air flotation (DAF) unit. The process units desirably include means for reducing erratic movement of the wastewater due to sea-induced movement of the marine vessel. The DAF unit includes a plurality of inclined baffles arranged to create a plurality of parallel inverted U-shaped flow paths that effect combined co-current and counter-current flotation separation while reducing erratic movement of the wastewater. The selection of process units and operating conditions advantageously reduces the footprint of the wastewater treatment system and reduces cost and complexity associated with the handling of wastewater treatment chemicals.

### FIELD OF THE INVENTION

The invention relates to the biological treatment of wastewater on a marine vessel. More particularly, the invention relates to a wastewater treatment system for a marine vessel wherein the unit operations of the system include design features for preventing erratic movement of the wastewater due to sea-induced movement of the marine vessel.

### BACKGROUND OF THE INVENTION

Wastewater treatment systems on marine vessels are becoming increasingly important due to tightening environmental regulations. These regulations particularly effect passenger carrying marine vessels, such as cruise ships, naval vessels, ferries and the like. The regulations set discharge criteria for “greywater” (laundry wash water, shower water, etc.) “blackwater” (toilets, oily wastewater, etc.) and sometimes “bilge water” (water due to infiltration, spills and plumbing leaks, typically accumulated in a lower portion of the vessel).

In land-based wastewater treatment systems, there are a great number of process configurations for treating combined greywater and blackwater. Initial solids removal is normally accomplished using screens and/or sedimentation tanks to remove large particulate matter from the wastewater. Primary or physical treatment is used to settle out solids, often in a large clarifier with a prolonged residence time to allow the particulate matter to settle. Flocculating agents are sometimes used to aid in the settling process. Biological treatment is often employed, with aerobic treatment using a suspended growth process (eg: activated sludge) being typical. Dissolved air flotation (DAF) is occasionally utilized to separate buoyant materials (eg: oils and greases) from the wastewater. DAF is normally conducted in a large tank with air introduced to the wastewater and dissolved under pressure prior to entering the tank so that a release of pressure in the tank causes micro-bubbles to form, which enhance the buoyancy of the materials being separated. The materials are skimmed off of the top of the tank and the treated wastewater normally overflows a weir at the top of the tank.

The foregoing processes have a number of limitations when applied to marine vessels. First, space is limited on a marine vessel, so a wastewater treatment system is required with minimal footprint. Clarifiers, activated sludge processes, and conventional overflow DAF tanks have too large of a footprint to be practically implemented on a marine vessel. Second, the overall retention time of the system is limited due to space, so treatment processes with fast kinetics are desirable. Residence times on the order of days, typical for clarification, activated sludge and conventional DAF processes, are simply not feasible on a marine vessel. Third, the system must be able to deal with variability in flow-rate and shock-loading due to varying concentration of pollutants in the wastewater. The aforementioned conventional processes are easily upset due to wide variations in flowrate and concentration, which can lead to washout of microbial cultures (in the case of suspended growth aerobic processes) and generally an inadequacy in meeting treatment objectives. Fourth, sea-induced movement of the marine vessel causes erratic movement of the wastewater, such as sloshing and potentially spillage, which both disrupts the treatment process and creates a potentially human health hazard. For these reasons and others, conventional processes cannot be employed on a marine vessel and there is accordingly a need for improved treatment methods and equipment.

A shipboard wastewater treatment system is disclosed in U.S. Pat. No. 6,361,695 to Husain, et al. This system utilizes a suspended growth biological treatment process and a hollow fiber membrane. In addition to the aforementioned disadvantages of suspended growth processes for marine applications, membranes have the disadvantage of requiring a high pressure drop and of rapidly fouling in oily wastewater, with a corresponding decrease in permeate and increased retentate volume for further treatment.

A shipboard fixed-bed bioreactor system is disclosed in U.S. Pat. No. 5,807,485 to Caplan, et al. This system is directed to the treatment of bilge water, not mixed greywater and blackwater, particularly bilge water contaminated with petroleum. The preferred microbial culture contains petroleum degrading organisms, which tend to have kinetics that are too slow for rapid treatment of greywater and blackwater. In addition, no means is included within any of the units for limiting erratic movement of the wastewater due to sea-induced movement of the ship.

A three zone dissolved air flotation clarifier with improved efficiency is disclosed in U.S. Pat. No. 5,863,441 to Krofta. The clarifier has parallel inclined baffles and an overall U-shaped flow pattern; however, the baffles are not arranged to create a plurality of U-shaped flow paths. The clarifier is not for use in marine applications and does not include features for mitigating erratic movement of wastewater due to sea-induced movement of a marine vessel.

Although DAF units having baffles creating U-shaped flow paths are known for land based applications, the baffles in these units are disposed only in a central zone of the unit and neither extend upwardly to a nominal waterline of the unit, nor downwardly to a bottom fluid distribution zone. Baffles extending to the nominal waterline are important to prevent erratic movement of the wastewater, particularly wastewater at the waterline, due to sea-induced movement of the marine vessel. These prior art DAF units also do not have both a fluid inlet and a fluid outlet at a bottom thereof, nor do they have discharge openings for each U-shaped flow path in a sidewall of the unit. A plurality of sidewall discharge openings are desirable in marine applications to limit the footprint of the unit, which is otherwise increased due to the need for sumps, weirs, collectors, etc., and to limit erratic movement of the wastewater in the sumps. Prior art DAF units normally are open topped to permit ease of maintenance and to permit introduced air to readily escape from the unit. In comparison, for marine vessel applications the desire to control odours in the enclosed space where the DAF unit is located lead to the preferable use of closed tops and odour control means.

Accordingly, there remains a need for an improved wastewater treatment system for a marine vessel.

### SUMMARY OF THE INVENTION

According to an aspect of the invention, there is provided a wastewater treatment system for a marine vessel comprising: a solids separator; an aerobic attached growth biological reactor; a flocculator comprising a plurality of tubular elements connected in serial fluid communication; and, a dissolved air flotation unit comprising a plurality of spaced apart baffles arranged to create a plurality of inverted U-shaped flow paths, each U-shaped flow path having wastewater flowing upwardly along a first side of the flow path and downwardly along a second side of the flow path, the baffles mitigating erratic movement of the wastewater due to sea-induced movement of the marine vessel.

According to another aspect of the invention, there is provided a wastewater treatment apparatus for use on a marine vessel, the apparatus comprising a dissolved air flotation unit comprising a plurality of spaced apart baffles arranged to create a plurality of inverted U-shaped flow paths, each U-shaped flow path having wastewater flowing upwardly along a first side of the flow path and downwardly along a second side of the flow path, the baffles mitigating erratic movement of the wastewater due to sea-induced movement of the marine vessel.

According to yet another aspect of the present invention, there is provided a method of treating wastewater at sea on a marine vessel, the method comprising: separating particulate matter from the wastewater; treating the wastewater aerobically using an attached growth process; adding a flocculating agent to the wastewater and flocculating the wastewater in a flocculator comprising a plurality of tubular elements connected in serial fluid communication; and, separating flocculated material from the wastewater by dissolved air flotation in a dissolved air flotation unit comprising a plurality of spaced apart baffles arranged to create a plurality of inverted U-shaped flow paths having wastewater flowing upwardly along a first side of each flow path and downwardly along a second side of each flow path, the baffles mitigating erratic movement of the wastewater due to sea-induced movement of the marine vessel.

The invention advantageously includes features for preventing erratic movement of the wastewater due to sea-induced movement of the marine vessel. In particular, the tubular flocculator is employed in order to provide the desired residence time in a controlled, non-erratic manner. Also, the DAF unit include internal baffles to prevent erratic movement of the wastewater and the baffles may extend upwardly to about the nominal waterline within the DAF unit to further prevent erratic movement at the waterline. Other advantageous features include low residence time requirements due to high kinetic rates, particularly within the biological reactor, which results in space and footprint savings. The system may advantageously utilize closed vessels and odour control means where appropriate to reduce the potential for unpalatable and potentially hazardous gas emissions within the confined space of the marine vessel. The odour control means may include activated carbon adsorption or external venting.

The fixed film aerobic bio-reactor may include a packed bed or trickling filter. In order to take advantage of the rapid mass transfer occurring with suspended growth processes in an effort to increase overall kinetic rates, a hybrid process may be utilized wherein a fixed film is grown on neutrally buoyant media having properties permitting fluidization. The media is preferably hollow so that the fixed film can grow on the inside of the media, thereby protecting the film from excessive sloughing due to fluid shear and abrasion with adjacent media. By fluidizing the media, mass transfer and overall kinetic rates are improved, which reduces the footprint and space requirements for the biological process. Examples of suitable fixed film fluidized bed bioreactors and processes for their use are provided in U.S. Pat. No. 5,543,039 and U.S. Pat. No. 6,126,829, which are both incorporated herein by reference for jurisdictions that permit this method. These exemplary reactors combine the advantages of both fixed film and fluidized bed operation in a single aerobic biological reactor.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1 is a process flow diagram showing the inter-relationship between units in an embodiment of a wastewater treatment system according to the present invention;

FIG. 2a is an end view of a tubular flocculator in accordance with an embodiment of a wastewater treatment system according to the present invention;

FIG. 2b is a side view of the tubular flocculator shown in FIG. 2a;

FIG. 3 is a schematic representation of a tubular flocculator showing a serpentine flow path;

FIG. 4a is a side cross-sectional view of a DAF unit according to an embodiment of the present invention; and,

FIG. 4b is a top view of the DAF unit of FIG. 4a.

### DESCRIPTION OF PREFERRED EMBODIMENT

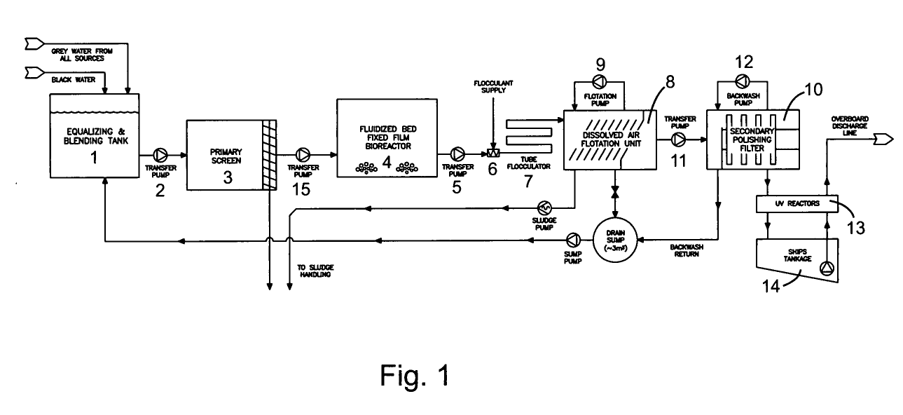

Referring to FIG. 1, greywater and blackwater from the marine vessel is first provided to an equalization and blending tank 1. A first transfer pump 2 is then used to direct the combined wastewater at a relatively constant flow rate through a primary screen 3 for performing solids separation. The separated solids are sent along with the sludge either to a handling and storage facility or to on-board incineration with optional de-watering and drying prior to combustion. A second transfer pump 15 is then used to provide sufficient pressure to the wastewater as it is transferred for aerobic biological treatment within a fluidized bed fixed film bioreactor 4.

The bioreactor 4 contains a plurality of neutrally buoyant inert structures for supporting the fixed film during fluidization. The neutrally bouyant inert support structures may comprise any suitable structure for supporting an attached biological film while being amenable to fluidization. For example, the structures may comprise cylinders, rings, saddles, or spheres. Preferably, the structures have a hollow interior for supporting a biological film, protecting the film from abrasion and shearing while permitting the passage of fluid past the film without plugging. The inert support structure may be made from any suitable neutrally buoyant material, for example high density polyethylene and may be formed using a mold or an extrusion process. The inert support structure is preferably tubular and preferably comprises Hydroxyl-PAC™ media.

In operation, wastewater is admitted into the bioreactor through the inlet and flows past the attached biological film on the fluidized support structures. Organic matter in the wastewater is consumed by the film in the production of additional biomass. Some of the produced biomass remains with the film and some of the biomass is sloughed off due to the shearing action of the passing fluid. Treated wastewater exits the bioreactor in a treated effluent stream. A portion of the treated effluent stream may be recycled (not shown) in order to maintain fluidization conditions within the bioreactor. The degree of treatment that takes place in the bioreactor is dependent in part on the hydraulic residence time and the biomass residence time. These parameters may be selected to achieve the desired treatment objectives for organic matter and/or particulate matter content. For example, the biomass residence time may be extended to increase digestion and reduce the solids concentration in the treated effluent.

Aerobic conditions within the bioreactor 4 are maintained by the addition of air to the wastewater prior to entering the bioreactor. This air is normally provided by the vessel's on-board compressed air supply (not shown) although air handling and air treatment equipment may also be provided to supply air of sufficient quality.

The fluidized bed fixed film bioreactor advantageously provides high rate aerobic treatment, reducing the required residence time and associated footprint, while also having a greater overall resilience with respect to shock loading than other biological treatment processes. In addition, the efficacy of the fluidized bed is essentially unaltered due to erratic movements of the wastewater caused by sea-induced movement of the vessel. Of course, those skilled in the art will appreciate that other types of aerobic biological treatment units may be used, although fixed film biological treatment processes are preferred both for their stability with respect to erratic wastewater movement and for their ability to deal with wide variations in contaminant concentration.

Following biological treatment, a third pump 5 is used to pump the wastewater and a flocculating agent is added to the wastewater with a flocculant injector 6. A static mixer may be used in conjunction with the flocculant injector 6 in order to uniformly distribute the flocculating agent within the wastewater following injection. The flocculating agent may comprise a polymeric flocculating agent or any other conventionally known flocculating agent suitable for wastewater treatment. Preferrably, the flocculating agent is suitable for use with wastewater containing oily substances. An example of a preferred flocculating agent is a highly charged cationic emulsion polymer such as Drewfloc™ 2468. After the flocculating agent is added, the wastewater enters the tubular flocculator 7.

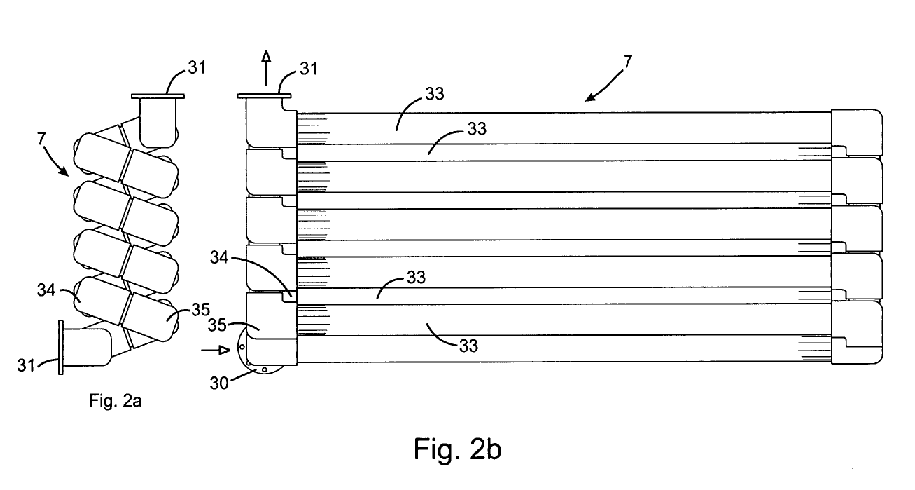

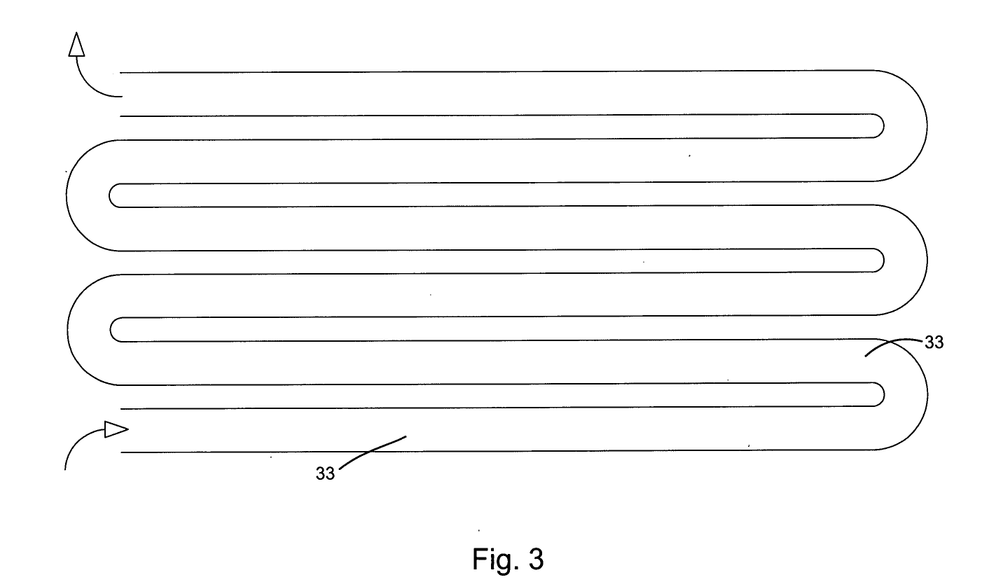

With reference to FIGS. 1-3, the tubular flocculator 7 comprises a flanged inlet 30, a flanged outlet 31 and a plurality of horizontal tubular pipes 33. Each pipe 33 is interconnected with an adjacent pipe by means of elbows 34, 35, which are arranged to form a substantially U-shaped connector. The pipes 33 are arranged to create a serpentine flow path as fluid passes serially from one pipe to the next. The serpentine flow path is illustrated schematically in FIG. 3 and provides the desired residence time for floc formation within a relatively small footprint. In comparison with conventional land-based wastewater treatment systems wherein flocculation is conducted within a large (typically open topped) vessel, the tubular flocculator advantageously provides the desired residence time in a manner that is not affected by sea-induced movement of the marine vessel. Since the water flows upwardly from the bottom of the tubular flocculator 7 to the top, the pipes 33 are full and there is no air-water interface that would otherwise be susceptible to erratic floc-disturbing movement. Wastewater flowing within the pipes is therefore relatively unaffected by sea-induced movements of the marine vessel. Furthermore, due to the fluid velocity within the pipes 33, the floc stays in suspension within the tubular flocculator without a tendency to settle. During experimental testing, it was found that use of the tubular flocculator enhanced flocculation efficiency sufficiently that a coagulation pre-treatment stage using a tri-valent metal salt such as ferric chloride (FeCl₃) or alum (Al₂O₃) could be advantageously eliminated without detrimental results on overall system performance. The tubular flocculator in combination with a suitable flocculating agent therefore advantageously allowed substantially all of the floc to be introduced to the DAF unit 8 for subsequent separation from the wastewater.

DAF processes are generally known in the art and comprise the dissolution of a gas within the wastewater whilst under pressure. The gas may be dissolved either by direct injection into the wastewater under suitable conditions or by mixing a liquid stream containing a high concentration of the dissolved gas with the wastewater prior to entry to the DAF unit 8. These gas dissolution operations are not shown in FIG. 1, but are well understood by persons skilled in the art. The gas may be either an inert gas or, as in the present invention, compressed air supplied from ship-board compressed air sources or dedicated locally situated air compressors. The wastewater is introduced under pressure into the DAF unit 8, where the controlled release of pressure from the fluid causes the gas to come out of solution in the form of micro-bubbles. These micro-bubbles agglomerate with the materials within the wastewater desired to be separated by flotation (for example, light-weight particulate matter, oily substances, grease or fat globules, etc.) and enhance their buoyancy, thereby increasing the rate of flotation. The separated materials are normally collected by a sludge scraper and the cleaned effluent normally exits in the prior art via an overflow weir located at an upper end of the separation zone.

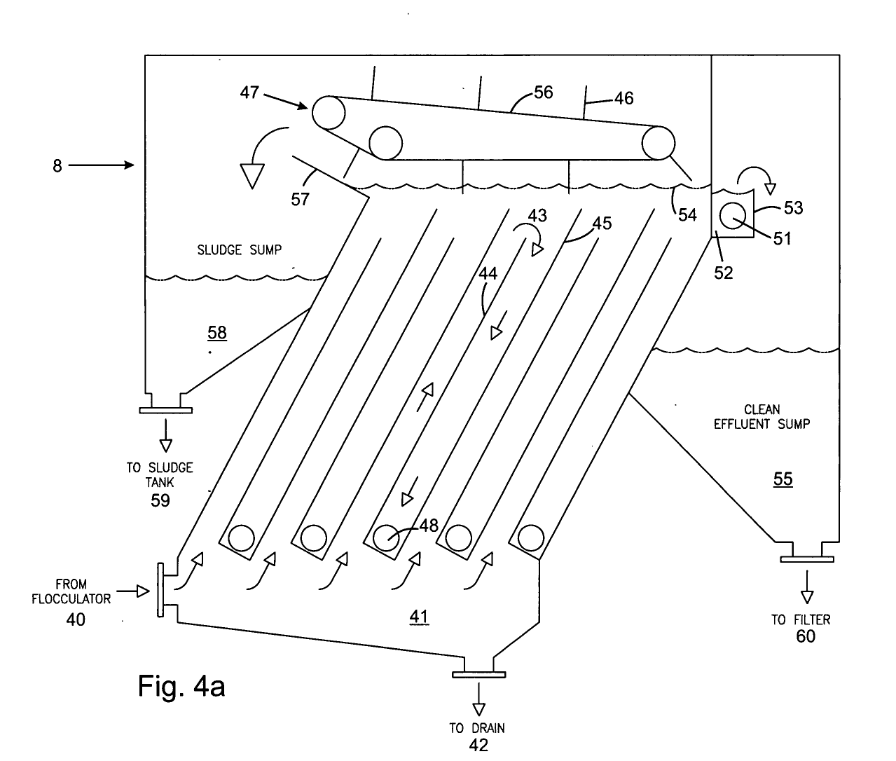

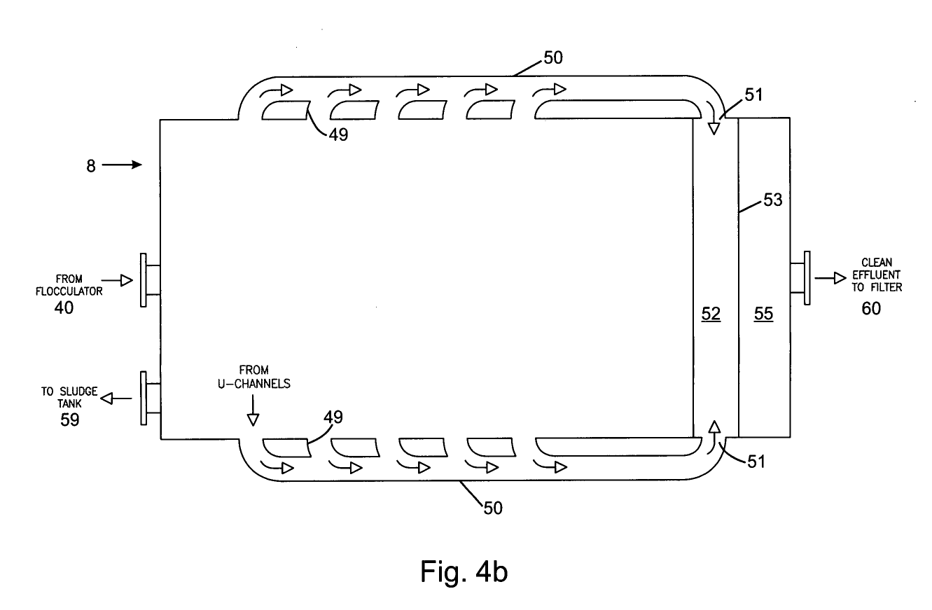

Referring to FIGS. 1 and 4, the DAF unit 8 according to the present invention comprises a bottom inlet 40 through which flocculated wastewater is introduced to a bottom distribution chamber 41. The distribution chamber 41 is designed to have a minimal depth in order to reduce the overall size of the DAF unit and includes a sloped bottom portion to permit occasional drainage of the DAF unit through drain 42 as needed for maintenance purposes. The wastewater from the distribution chamber 41 flows upwardly in parallel relation through a plurality of inverted U-shaped flow passages 43. Each U-shaped passage 43 is formed by a pair of spaced apart baffles 44, 45 that are joined at their bottom edges to close a downward portion of the U-shaped flow passage. In each pair of spaced apart baffles, a first baffle 44 is lower in height than a second baffle 45. This permits the wastewater to flow upwardly over the top of the baffle 44 and make a downward turn for entry into the downward leg of the U-shaped flow passage 43. The second baffle 45 extends upwardly to just below the nominal waterline 54 of the DAF unit 8. For example, the second baffle 45 extends upwardly to about 10-15 cm below the nominal waterline 54 in order to provide sufficient clearance for the flights 46 of sludge scraper 47 and to allow normal water level fluctuations due to variations in flow rate and/or sea-induced movement of the marine vessel. By extending to just below the nominal waterline 54, the second baffle 45 causes the majority of the fluid in the U-shaped flow path 43 to transit the turn at the top of the first baffle 44 and thereby travel down the downward portion of its respective flow path 43. The height of the second baffle 45 also advantageously dampens any sea-induced erratic movement of the waterline 54, thereby preventing the floc within the wastewater from being disturbed and protecting the sludge blanket from being disrupted, which in turn would cause previously separated particulate matter to be re-introduced into the downward leg of the U-shaped flow path 43 with detrimental results on overall performance of the DAF unit 8.

In the DAF unit 8 of the present invention, a co-current flotation separation occurs on the upward portion of the inverted U-shaped flow path 43. This co-current separation advantageously exacerbates the flotation of highly buoyant materials. Less buoyant materials are entrained in the wastewater and pass over the first baffle 44 into the downward portion of the inverted U-shaped flow path 43. A counter-current flotation separation occurs on the downward portion of the U-shaped flow path 43 where less buoyant materials are provided with sufficient residence time that their micro-bubbles may agglomerate, thereby increasing the buoyancy of the materials and allowing them the opportunity to rise to the nominal waterline 54. The combination of co-current followed by counter-current separation advantageously increases the efficacy of the flotation separation and allows the overall size and footprint of the DAF unit 8 to be reduced as compared with prior art flotation separation systems.

After passing through the downward portion of the inverted U-shaped flow path 43, the wastewater exits the DAF unit 8 through a plurality of exit orifices 48 within the sides of the DAF unit. As can be seen with reference particularly to FIG. 4b, the wastewater exits the DAF unit 8 through side pipes 49 and enters collector piping 50. The collector piping 50 is then vertically inclined towards a weir inlet 51 that admits the wastewater to an internal weir chamber 52. The internal weir chamber 52 only has fluid communication with the main separation portion of the DAF unit 8 through the collector piping 50. By adjusting the height of level-control weir 53, the position of the nominal waterline 54 within the DAF unit can be selected. Adjustment of the position of the waterline may be advantageous, for example, in conditions where a significant amount of separated particulate material is required to be removed by the sludge scraper 47. Wastewater overflowing the level-control weir 53 falls into effluent sump 55 and exits the DAF unit 8 downwardly through effluent opening 60 in an effort to further reduce the overall footprint of the unit. A flotation pump 9 is used to re-circulate effluent from the sump 55 back to the inlet 40 of the DAF unit 8 and receives an injection of compressed air (not shown) in order to supply dissolved gas to the DAF unit for micro-bubble formation causing flotation separation.

The sludge scraper 47 comprises an endless belt 56 which passes over a drive pulley and a pair of idler pulleys. The idler pulley nearest the anterior end of the DAF unit 8 is elevated with respect to the other pulleys in order to create an upwardly inclined section of the endless belt 56 corresponding in angle to a sludge ramp 57. Attached substantially perpendicularly to the endless belt 56 are scraper flights 46. As the endless belt 56 rotates in a clockwise fashion about the pulleys, the flights 46 engage the sludge blanket floating at the nominal waterline 54 and act upon it to move separated particulate matter towards the anterior end of the DAF unit 8 and up the inclined sludge ramp 57. The sludge then falls off the end of the sludge ramp 57 and is deposited within a sludge sump 58 that is periodically emptied through a downwardly oriented sludge exit opening 59. The sludge exit opening 59 is oriented downwardly in an effort to reduce the overall footprint of the DAF unit 8. Sludge is mixed with other particulate material produced during the process, such as screen tailings from the primary screen 3, and either held within a storage tank for subsequent disposal or optionally dried and incinerated.

Referring again to FIG. 1, the effluent of the DAF unit 8 is provided to a polishing filter 10 by means of a fourth transfer pump 11. The polishing filter 10 may comprise either a media-based depth filter, a fixed element filter, a filter cloth based plate and frame filter, or any other suitable polishing filter type. In one embodiment, the polishing filter 10 comprises at least one rotating disc comprising a plurality of pie-shaped elements covered in a filter cloth. Rotation of the disc permits periodic backwashing of the pie-shaped elements and/or removal of the filter cloth. A backwash pump 12 is provided for this purpose. The polishing filter 10 may optionally be augmented by membrane filtration as a tertiary polishing step, depending on effluent treatment objectives and the intended end use of the treated wastewater. However, membrane filters are generally not preferred for the secondary polishing filter 10 due to maintenance and reliability concerns, the associated pressure drop at the overall system flow rates, and the overall cost of membrane filters for shipboard applications.

Following polishing filtration, the wastewater enters an ultraviolet (UV) disinfection unit 13 for inactivation of bacteria, viruses, algae and parasites prior to eventual disposal. In the process configuration shown, UV irradiation is employed following polishing and prior to storage of the wastewater in an effluent holding tank 14. In emptying the holding tank 14, the flow of wastewater through the system is stopped and the tank is emptied through the UV disinfection unit 13. This process configuration permits the wastewater to be disinfected a first time prior to storage, reducing the toxicity of the effluent in the event of a spill and also maintaining overall storage tank cleanliness, and also permits the wastewater in the storage tank to be disinfected a second time immediately prior to disposal in the event that any re-growth or photo re-activation has occurred during storage. Chemical disinfectants may optionally be used to augment or replace the UV disinfection unit 13, albeit less desirably due to safety concerns associated with the handling or on-site generation of these disinfectants.

A number of the unit operations shown in FIG. 1 require venting due to fluctuations in water level or the addition of gases during operation. In order to mitigate health and safety concerns, theses unit operations are normally vented to an exterior of the marine vessel (for example, through the ship's ventilation system) and the unit operations are desirably operated under a slight negative pressure to prevent fugitive emissions. Optional odour control means, such as activated carbon, may be employed in conjunction with gas venting to minimize odours prior to discharge and enhance operator safety within the confines of the wastewater treatment room.

Other advantages which are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A wastewater treatment system for a marine vessel comprising:
a) a solids separator;
b) an aerobic attached growth biological reactor;
c) a flocculator comprising a plurality of tubular elements connected in serial fluid communication; and,
d) a dissolved air flotation unit comprising a plurality of spaced apart baffles arranged to create a plurality of inverted U-shaped flow paths, each U-shaped flow path having wastewater flowing upwardly along a first side of the flow path and downwardly along a second side of the flow path, the baffles mitigating erratic movement of the wastewater due to sea-induced movement of the marine vessel.

2. The system according to claim 1, wherein the downward portion of each inverted U-shaped flow path is closed and wherein the wastewater exits the dissolved air flotation unit after completing the downward portion of the inverted U-shaped flow path.

3. The system according to claim 1, wherein the tubular elements are horizontal.

4. The system according to claim 3, wherein the flocculator comprises a serpentine flow path.

5. The system according to claim 1, wherein a flocculating agent is injected into the wastewater prior to entering the flocculator.

6. The system according to claim 1, wherein the biological reactor comprises a fixed film fluidized bed biological reactor.

7. The system according to claim 6, wherein the biological reactor comprises a plurality of hollow spherical packing elements having the fixed film growing on an interior thereof.

8. The system according to claim 1, wherein the solids separator comprises a screen or filter.

9. A wastewater treatment apparatus for use on a marine vessel, the apparatus comprising a dissolved air flotation unit comprising a plurality of spaced apart baffles arranged to create a plurality of inverted U-shaped flow paths, each U-shaped flow path having wastewater flowing upwardly along a first side of the flow path and downwardly along a second side of the flow path, the baffles mitigating erratic movement of the wastewater due to sea-induced movement of the marine vessel.

10. The apparatus according to claim 9, wherein the wastewater enters and exits the dissolved air flotation unit at a bottom thereof.

11. The apparatus according to claim 9, wherein the wastewater exits the dissolved air flotation unit through a plurality of discharge openings in a sidewall thereof.

12. The apparatus according to claim 9, wherein the wastewater exits the dissolved air flotation unit after completing the downward portion of a single inverted U-shaped flow path.

13. The apparatus according to claim 9, wherein each U-shaped flow path is created by a pair of spaced apart baffles from the plurality of spaced apart baffles, each pair of spaced apart baffles comprising a first and second baffle, the second baffle extending upwardly to about a nominal waterline of the dissolved air flotation unit to thereby mitigate erratic movement of the wastewater at the waterline due to sea-induced movement of the marine vessel.

14. The apparatus according to claim 13, wherein the first and second baffle extend downwardly to a bottom fluid distribution zone of the dissolved air flotation unit.

15. The apparatus according to claim 14, wherein the wastewater enters the U-shaped flow paths at a bottom thereof and wherein the U-shaped flow paths are arranged for parallel fluid communication with the bottom fluid distribution zone.

16. The apparatus according to claim 15, wherein the first and second baffles are connected at a lower end thereof to thereby close the second side of each inverted U-shaped flow path.

17. The apparatus according to any one of claim 9, wherein the dissolved air flotation unit has a downwardly oriented effluent discharge opening.

18. A method of treating wastewater at sea on a marine vessel, the method comprising:
a) separating particulate matter from the wastewater;
b) treating the wastewater aerobically using an attached growth process;
c) adding a flocculating agent to the wastewater and flocculating the wastewater in a flocculator comprising a plurality of tubular elements connected in serial fluid communication; and,
d) separating flocculated material from the wastewater by dissolved air flotation in a dissolved air flotation unit comprising a plurality of spaced apart baffles arranged to create a plurality of inverted U-shaped flow paths having wastewater flowing upwardly along a first side of each flow path and downwardly along a second side of each flow path, the baffles mitigating erratic movement of the wastewater due to sea-induced movement of the marine vessel.

19. The method according to claim 18, wherein the method further comprises filtering the wastewater following dissolved air flotation and prior to discharging the wastewater from the marine vessel.

20. The method according to claim 19, wherein the method further comprises disinfecting the wastewater using ultraviolet radiation following filtration and prior to discharging the wastewater from the marine vessel.
